(19) United States
(12) Patent Application Publication
(10) Pub. No.: US 2026/0108855 A1
(43) Pub. Date: Apr. 23, 2026

(54) MIXING CHAMBER SYSTEM

(71) Applicant: XIM LLC, Cottonwood Heights, UT (US)

(72) Inventor: Tayler Scharman, Riverton, UT (US)

(73) Assignee: XIM LLC, Cottonwood Heights, UT (US)

(21) Appl. No.: 19/115,083

(22) PCT Filed: Dec. 22, 2023
(86) PCT No.: PCT/US2023/085677

§ 371 Date: Mar. 25, 2025

Related U.S. Application Data
(60) Provisional application No. 63/435,132, filed on Dec. 23, 2022.

(51) Int. Cl. B01F 27/112; B01F 23/53; B01F 27/15; B01F 27/90; B01F 35/221; B01F 35/32; B01F 35/71; B01F 101/14

(52) U.S. Cl. CPC B01F 27/112; B01F 23/53; B01F 27/15; B01F 27/90; B01F 35/221422; B01F 35/2217; B01F 35/2218; B01F 35/3204; B01F 35/712; B01F 35/714; B01F 2101/14; B01F 2215/0481

(57) ABSTRACT

The invention provides a fluid mixer with a fluid reservoir, a ring within the fluid reservoir, a stirrer rotatably coupled in the ring, and a motor to rotate the stirrer. The ring has a wall defining an inner and outer portion of the fluid reservoir, with wall cutouts that allow fluid to pass from the inner portion to the outer portion. The stirrer has a center and multiple paddles, and the rear surface of a first paddle and the front surface of a second paddle define a mixing space, and rotation of the paddles pushes a fluid from the mixing space through one of the cutouts into the outer portion. The invention also provides a method of mixing a fluid, including introducing liquid into a fluid reservoir and a powder into a powder dispenser, activating a stirrer, and dispensing the powder into the liquid while the stirrer is rotating.

### CROSS REFERENCE

This application claims benefit from currently pending U.S. Provisional Application No. 63/435,132 titled “Mixing Chamber System” and having a filing date of Dec. 23, 2022, and all of which is incorporated by reference herein.

### FIELD OF THE INVENTION

The present specification relates generally to devices for mixing powders and more specifically for a mixing chamber system that accepts and mixes powders and liquids into one mixed aqueous solution or slurry.

### BACKGROUND OF THE INVENTION

Mixing of fluids, particularly liquids and powders, is a common process in various industries such as food, pharmaceutical, and chemical industries. The mixing process is crucial in achieving a homogeneous mixture, which is often required for the subsequent processes or for the final product. The mixing process can be challenging, especially when dealing with different types of materials such as liquids and powders.

Food processors are common on the market today and are designed to mix, cut, chop, blend or otherwise process foods and powders. Given the advent of health-conscious individuals, there are people that are prioritizing their eating and drinking habits. As such, people are buying accessories to accompany this healthy lifestyle to help make their food and drinks easier for consumption. Individuals have developed regular fitness regimes that ensure they eat properly, exercise daily and get the proper nutrition for their bodies to recover. Recovery can be assisted by mixing protein and vitamin powders into their diet. These powders are often mixed with food or liquids and are usually consumed in the morning or close to the time of exercise.

Since these proteins and vitamins are mixed into liquid it is common that proteins and vitamins are stored separate from the liquid until the time of consumption. Various products have been developed to assist in mixing these powders in with the liquids. For instance, some powders are mixed in bottles that contain a whisking ball that when the bottle is shaken the whisking ball moves vigorously within the bottle mixing the powder within the liquid. Other bottles have a main container housing that stores the liquids and a housing to store the powders and allows the user to release the powder into the liquid when ready for use and then uses an impeller to mix the powder into the liquid, which requires the user to constantly wash and add more liquid and powder into the housings. Further, adding ice into the container requires the user to mix the powder into the liquid first, and then add ice after the mixing is complete.

Further, individuals have developed products that will automatically mix and then dispense protein powders and water in one solution. Traditional fluid mixers often use a simple stirring mechanism to mix the materials. However, these mixers may not provide a thorough and efficient mixing, especially when dealing with a large volume of materials. In addition, these mixers may not be able to handle different types of materials effectively. For example, when mixing a liquid with a powder, the powder may not be fully dispersed in the liquid, resulting in a non-homogeneous mixture. However, the mixing doesn't cool or heat the liquid, or mixes the protein completely with the water coming out in clumps of powder in the water. These systems have some major disadvantages in that they do not emulsify the powder, water and fruit, if user desires, together completely nor do they allow the user to add either hot or cold liquid. In addition, these types of products are not removable from the main system. Current methods of mixing have powders that are added from the surface (top) and are usually difficult to wet and difficult to disperse, which creates “lumps”/agglomerates in the mixture.

Therefore, there is a need for a system that can effectively mix powders and liquids into one complete mixture without lumps and then dispenses it for the user.

### BRIEF SUMMARY OF THE INVENTION

Accordingly, the present invention provides a system and method for mixing fluids. A fluid mixer is provided with a fluid reservoir and a columnar wall defining a stirring section inner portion and outer portion of the fluid reservoir. The wall has at least one wall cutout that allows fluid to pass from the stirrer inner portion to the outer portion of the reservoir. A stirrer is rotatably fixed within the inner portion having a plurality of paddles that can be operated by a motor to stir the fluid. A mixing space is formed between the paddles of the stirrer and when the stirrer is rotated the mixing fluids are passed from the space through the cutouts in the wall and out into the outer portion of the reservoir.

The fluid mixer is designed to mix at least one liquid with at least one powder, and includes a liquid inlet through which the at least one liquid is introduced into the fluid reservoir, and a powder inlet at the top of the reservoir through which the at least one powder is introduced into the fluid reservoir. The powder inlet may be above the stirrer such that powder is dispensed into the stirrer to be stirred into the liquid.

The fluid mixer also includes a liquid measurer to allow a predetermined amount of the at least one liquid to be introduced into the fluid reservoir and a powder measurer to allow a predetermined amount of the at least one powder to be introduced into the fluid reservoir. The liquid may be measured by the volume of the liquid and the powder may be measured by its weight.

The invention also provides a method of mixing a fluid, which includes providing a powder dispenser arranged over a fluid mixer such that powder from the powder dispenser will be dropped into the fluid mixer, introducing at least one liquid into the fluid reservoir and at least one powder into the powder dispenser, and activating the motor to rotate the stirrer and dispensing the at least one powder from the powder dispenser into the liquid while the stirrer is rotating. The method also includes allowing a user to set a predetermined volume of the at least one liquid and a predetermined weight of the at least one powder, and introducing the predetermined volume of the at least one liquid into the fluid reservoir and dispensing the predetermined weight of the at least one powder from the powder dispenser.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the. Absent such clear statements of intent to apply a “special” definition, it is the inventor's intent and desire that the simple, plain, and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for” and will also recite the word “function” (i.e., will state “means for performing the function of . . . , without also reciting in such phrases any structure, material or act in support of the function. Thus, even when the claims recite a “means for performing the function of molding a . . . , step for performing the function of molding a . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

Additional features and advantages of the present specification will become apparent to those skilled in the art upon consideration of the following detailed description of the illustrative embodiment exemplifying the best mode of carrying out the invention as presently perceived.

### BRIEF DESCRIPTION OF THE DRAWINGS

These and other features, aspects, and advantages of the present specification will become better understood with regard to the following description, appended claims, and accompanying drawings where:

FIG. 1 is an isometric view of the assembled mixing chamber assembly in accordance to one or more embodiments;

FIG. 2a is a front view of the mixing chamber assembly in accordance to one, or more embodiments;

FIG. 2b is a cross-sectional view of the mixing chamber of FIG. 2a;

FIG. 3 is exploded perspective view of the mixing chamber assembly in accordance to one, or more embodiments;

FIG. 4 is an overhead view of the fluid reservoir of the mixing chamber assembly of FIG. 3;

FIG. 5 is an exploded perspective view of the lid of the mixing chamber assembly in accordance to one, or more embodiments;

FIG. 6 is a perspective view of the mixer of the mixing chamber assembly in accordance to one, or more embodiments;

FIG. 7 is an exploded overhead perspective view of the mixer of FIG. 6; and

FIG. 8 is an exploded bottom view of the mixer of FIG. 6.

Elements and acts in the figures are illustrated for simplicity and have not necessarily been rendered according to any particular sequence or embodiment.

### DETAILED DESCRIPTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

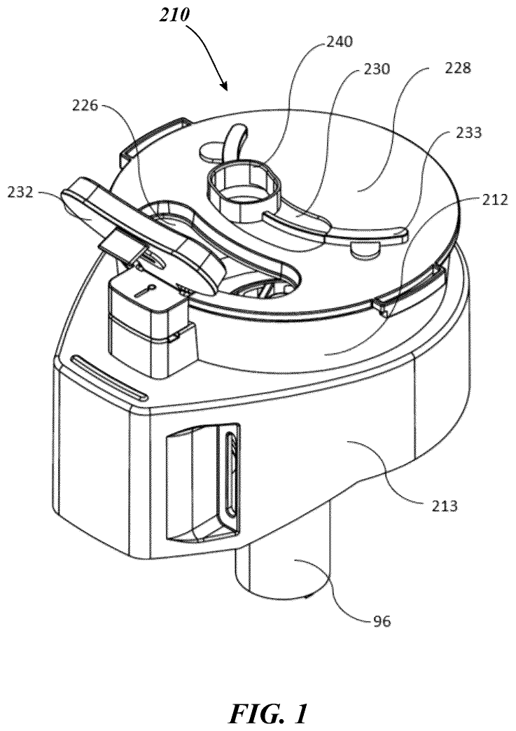

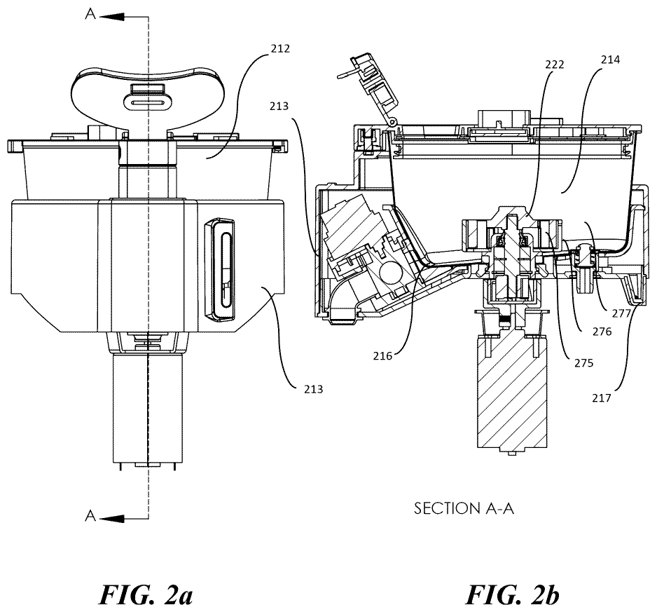

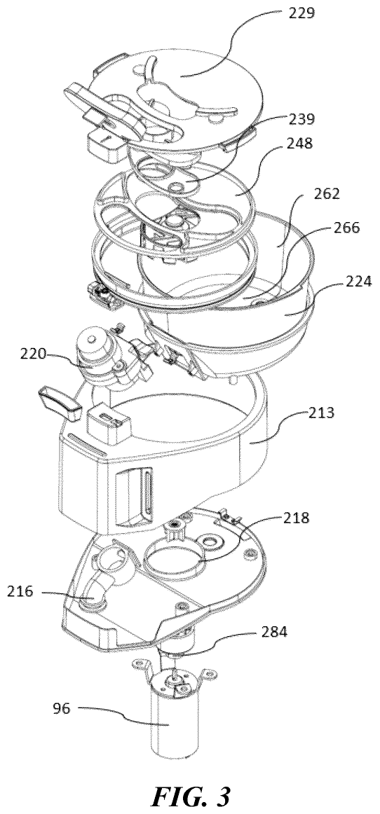

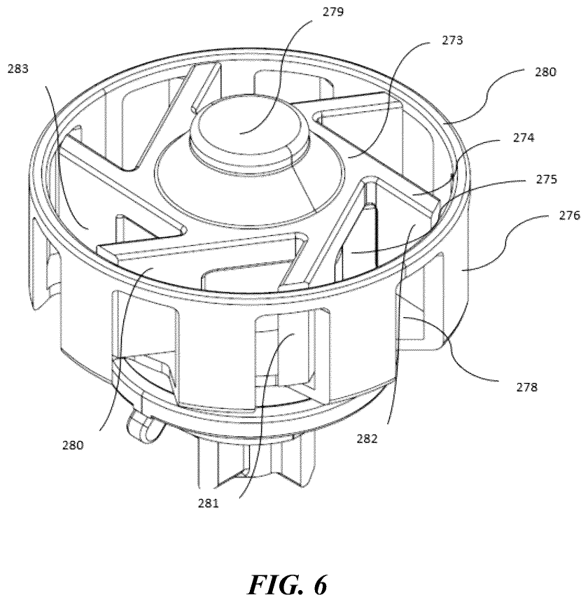

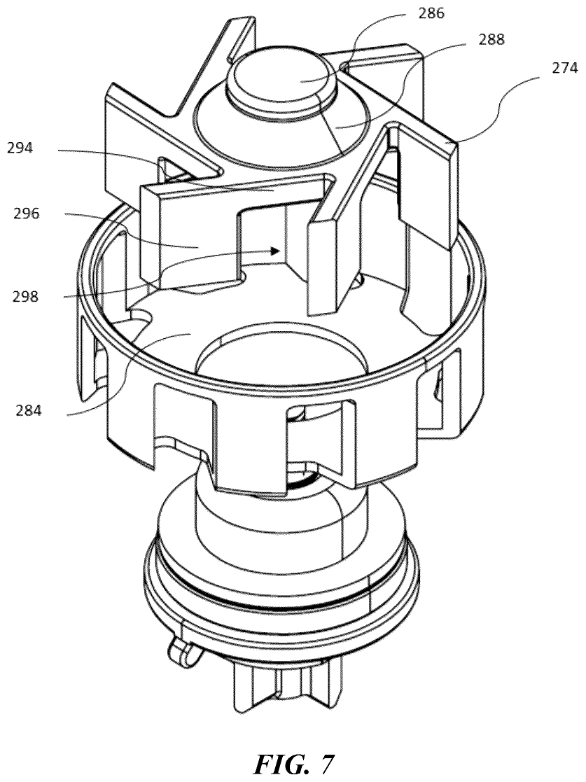

Referring initially to FIGS. 1-8 a mixing chamber system in shown generally at 210. The mixing chamber 210 can comprise fluid reservoir 212 in a base 213. The fluid reservoir 212 is a container designed to hold the fluid to be mixed. The fluid reservoir 212 can be made of any suitable material that is resistant to the fluid to be mixed. The fluid reservoir 212 can be of any suitable size and shape, depending on the volume of fluid to be mixed.

The fluid reservoir 212 can be a shell having an interior 214 and an external surface 224. The fluid reservoir 212 can have an open top 229 and a lid 228. In embodiments, the fluid reservoir 214 can contain a mixer 270 having a wall 276 defining a mixing interior portion 275 and a mixing outer portion 277. The wall can be a columnar ring or any other suitable shape or cross section. The wall 276 may have at least one cutout 278. The wall cutouts can be of any suitable size and shape, and can be arranged in any suitable pattern on the wall of the ring. In a particular embodiment, the wall 276 has nine evenly spaced cutouts 278. The wall cutouts 278 allow the fluid to flow from the inner portion 275 to the outer portion 277 of the fluid reservoir 212, thereby facilitating the mixing of the fluid.

The wall 276 of the mixer 270 may be fixed and mixer 270 may have a stirrer 273 rotatably coupled in the interior portion 275. The stirrer 273 has a center 279 and a plurality of paddles 274. Each paddle 274 has a front surface 280, a rear surface 282, and a front edge 281 that extends nearly to the wall 276. The rear surface 282 of a first paddle and the front surface 280 of a second paddle define a mixing space 283. The rotation of the paddles 274 pushes the fluid from the mixing space 283 through one of the wall cutouts 278 into the outer portion of the fluid reservoir 212. The paddles 274 can create a high shear for particle size reduction that does not require a massive amount of power to effectively product the same output of a traditional blender blades.

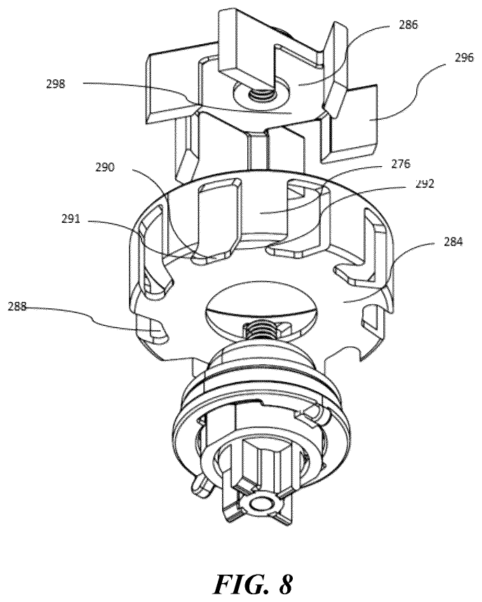

Referring to FIG. 8, the inner portion 275 of the mixer 270 has a bottom 284 and the stirrer 273 has a top 286. Each of the paddles 274 of the stirrer 270 has a connector portion 294 and a stirring portion 296. The connector portion 294 extends from the top 286 of the stirrer 273 toward the bottom 284 of the inner portion 275 of the fluid reservoir 212. The stirring portion 296 extends farther from the top 286 of the stirrer 273 toward the bottom 284 of the inner portion 275 of the fluid reservoir 212. The stirring portion 296 defines an open interior 298 of the stirrer.

The top of the stirrer 273 may have a substantially circular central portion 288. The connector portion 294 of each paddle 274 extends radially from a tangent to the circular central portion 288. The stirring portion 296 of each paddle 274 extends radially from the connector portion 294. The central portion 288 of the stirrer may be coextensive with the open interior 298 of the stirrer. The front edge 281 of each paddle may be angled. That is, the intersection of the front edge 281 with the rear surface 282 may extend radially farther than the intersection of the front edge 281 with the front surface 280 of the paddle 274. The front edge 281 of each paddle may alternatively be contoured to match the curve of the wall 276 of the mixer 270.

The mixer bottom 284 may be held above the reservoir bottom 266. The mixer bottom 284 may have a floor cutout 288 that extends from the wall cutout. The floor cutout 288 has a front 290, a first side 291, and a second side 292. The first side 291 meets the wall 276 of the mixer 270 at a substantially acute angle and the second side 292 meets the wall 276 at a substantially obtuse angle.

The fluid mixer is designed to mix at least one liquid with at least one powder. The fluid mixer further comprises a liquid inlet 216. The liquid inlet 216 is used to introduce the liquid into the fluid reservoir 212. The powder inlet 240 is used to introduce the powder into the fluid reservoir 212. The liquid inlet 216 introduces the liquid into the outer portion 277 of the fluid reservoir 212. The powder inlet 240 is at least partially above the inner portion 275 of the fluid reservoir 212. When the powder is introduced through the powder inlet 240, at least a portion of the powder falls into the inner portion 275 of the fluid reservoir 212. The fluid mixer further comprises a liquid measurer and a powder measurer. The liquid measurer is used to allow a predetermined amount of the liquid to be introduced into the fluid reservoir. The powder measurer is used to allow a predetermined amount of the powder to be introduced into the fluid reservoir.

The motor 96 is used to rotate the stirrer 273. The motor 96 can be of any suitable type, such as an electric motor, a hydraulic motor, a pneumatic motor, or the like. The motor can be connected to the stirrer in any suitable manner, such as by a direct connection, a belt drive, a chain drive, a gear drive, or the like. The motor 96 can be controlled to rotate the stirrer 273 at any suitable speed, depending on the type of fluid to be mixed and the desired degree of mixing.

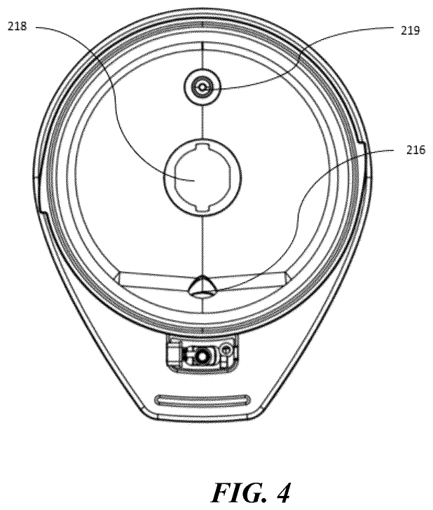

A dispensing valve 220, and a liquid valve connection 221 allows introduction of a fluid into the fluid reservoir 212. The reservoir 212 can be any suitable shape but in the preferred embodiment the mixing chamber housing can be the shape as shown in FIG. 4. The reservoir 212 can have a liquid dispensing hole 216, a motor hole 218, and a liquid valve hole 219.

The reservoir can be connected to a base 213. The base can have a first shelf 217 and can couple to the upper housing 212 by such as for example, snaps, clips, adhesive, fasteners or the like.

The lid 228 of the mixing system has a powder inlet 240 through which a powder may be dispensed into the fluid reservoir 212. The powder inlet 240 is on a hole slider 230 that allows the powder inlet 240 to be rotatable between an open and a closed position. The lid may also have a port 226 and a port lid 232.

The lid 228 may have a top panel 229, a slider tray 248 and a lid bottom 235. The slider 230 is placed within a cutout in the slider tray 248 resting atop the lid bottom 235. The lid bottom has an opening 236 and a closed recess 237. When the powder inlet 240 is rotated above the opening 236 powder may be dispensed into the reservoir 212 and when the powder inlet 240 is above the closed recess 237 the closed recess on the lid bottom 235 prevents any powder from entering the reservoir 212.

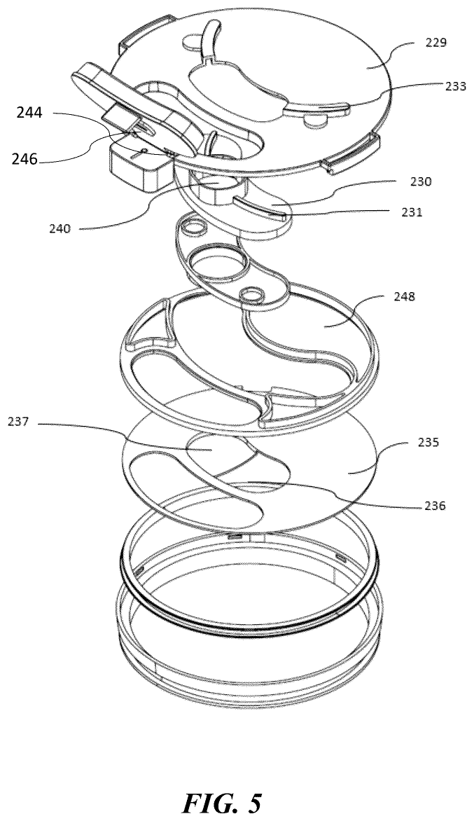

The hole slider 230 has a slide rail 231 that interacts with a slider guide 233 that directs and constrains the movement of the slider 230.The slider guide 233 can be integral to the mixing chamber lid or it can be separate and coupled to the mixing chamber lid. The slider guide 233 can be at least one groove or guide, as shown in FIG. 5, that can accept and guide a mixing chamber slider 230.

The slider rail 231 and the slider guide 233 can be substantially the same shape wherein the slider rail can follow the inside of the slider guide wherein the slider rail and slider guide can be such as, for example, square, circular, rectangular, or the like in shape. The mixing chamber slider 230 can follow the slider guide 242 wherein the slider guide can be such as, for example, a channel, groove, or the like. The mixing chamber slider 230 can move from an open position to a closed position aligning the powder inlet 240 with the slider hole 231 allowing powders to be dropped into the mixing chamber. The mixing chamber slider 230 can have at least one magnet (not shown) that can hold the slider open or closed.

The mixing chamber slider 230 can slowly add powder at the beginning of a mix cycle, which can prevent the powder from agglomerating and/or sticking to sides of the reservoir 212, which can also allow the mixture to slow increase in its viscosity, resulting in a quieter, smaller motor that produces a better outcome than traditional blending methods in faster times. The powder can be mixed into a liquid in an already low-speed mix cycle which can limit air-incorporation, then once powder is fully dispensed and dispersed, the speed of the mixing blade increases to further shear down the product particles within in the liquid mixture.

The mixing chamber lid 228 can have a port 226 wherein a port lid 232 can be removably coupled to the mixing chamber lid 228 by a port hinge 244 which can allow the port lid to open and close. The port lid 232 can have a second port hole 246 and a second port hole cover 238 wherein the port hole cover can be removably coupled to the second port hole. The port hole cover 238 can be made from such as, for example, rubber, plastic, metal, or the like. The port hole cover 238 can be a steam/pressure valve wherein as hot liquids enter the mixing chamber the port hole cover can release the pressure or steam, so the mixing chamber does not get pressurized. The port hole cover 238 can be such as, for example, pressure relief valve, air release valve, check valve, duckbill valve, one-way valve or the like.

The liquid dispensing hole 216 can allow the dispensing valve 220 to be couple and sealed to reservoir 212 by such as, for example, adhesive, fasteners, rivets, press fit, or the like. The dispensing valve 220 can be any mechanical or electrical valve having a dispensing hole and can be, such as, for example, check valve, solenoid valve, gate valve, mixing valve, or the like. The dispensing valve 220 can be open and closed by an electrical signal and can measure the flow of the liquid and how much the liquid is being dispensed.

The liquid valve connection 221 can be such as, for example, one way valve, check valve, ball valve, flap valve, non-return valve, cross-slit valve or the like allowing the liquid to flow from an outside liquid source to the inside of the mixing chamber 224 without allowing liquid to flow out of the mixing chamber. The liquid valve connection 221 can be coupled to the reservoir 212 creating a watertight seal by such as, for example, adhesive, fasteners, rivets, press fit, or the like. In certain embodiments, the liquid valve connection 221 can be integral to the reservoir 212.

The mixer 270 can simultaneously pulls liquid, powder, and product from both the top and bottom of the mixing chamber during a batched mixing cycle rapidly ‘wet’ powders and can disperse ingredients to create agglomerate-free mixtures and more stable emulsions. The motor 96 can be such as, for example, DC motor, stepper motor, AC motor, brushless motor, or the like. The mixing chamber system 210 can further comprise an electrical system that can control the powder dispenser, the speed of the motor 96 and dispensing valve 220.

The present invention also relates to a method of mixing a fluid. The method comprises the steps of providing a powder dispenser arranged over the fluid mixer, introducing at least one liquid into the fluid reservoir 212 and at least one powder into the powder dispenser, and activating the motor 96 to rotate the stirrer 273. The powder is dispensed from the powder dispenser 240 into the liquid while the stirrer 273 is rotating. The method further comprises the steps of allowing a user to set a predetermined volume of the liquid and a predetermined weight of the powder, introducing the predetermined volume of the liquid into the fluid reservoir, and dispensing the predetermined weight of the powder from the powder dispenser.

The method further comprises the steps of introducing the liquid into the fluid reservoir 212 through a liquid inlet 216, and introducing the powder into the fluid reservoir 212 through a powder inlet 240. The liquid inlet 216 introduces the liquid into the outer portion 277 of the fluid reservoir 212. The powder inlet 240 is at least partially above the inner portion 275 of the fluid reservoir 212. When the powder is introduced through the powder inlet 240, at least a portion of the powder falls into the inner portion 275 of the fluid reservoir 212. The method further comprises the step of allowing a user to set the rotation speed of the stirrer 273 between 1 rpm and 15,000 rpm. The method further comprises the step of stirring the powder as the powder is being dispensed from the powder dispenser to prevent clumping an allow a more uniform powder distribution on dispensing the powder into the mixing assembly 210.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

1. A fluid mixer comprising:
a fluid reservoir;
a ring within the fluid reservoir having a columnar wall defining an inner portion and an outer portion of the fluid reservoir, the wall having at least one wall cutout that allows fluid to pass from the inner portion to the outer portion;
a stirrer rotatably coupled in the ring, the stirrer having a center and plurality of paddles, each paddle having a front surface, a rear surface and a front edge that extends nearly to the wall;
a motor to rotate the stirrer;
wherein the rear surface of a first paddle of the plurality of paddles and the front surface of a second paddle of the plurality of blades define a mixing space and wherein rotation of the paddles pushes a fluid from the mixing space through one of the plurality of cutouts into the outer portion.

2. The fluid mixer according to claim 1, wherein the inner portion has a bottom and the stirrer has a top and, wherein each of the plurality of paddles has a connector portion and a stirring portion extending from the top toward the bottom of the inner portion, and wherein the stirring portion extends farther from the top of the paddle assembly toward the bottom of the inner portion to define an open interior of the paddle assembly.

3. The fluid mixer of claim 2 wherein the top of the top of the paddle assembly has a substantially circular central portion and wherein the connector portion of the plurality of paddles extend radially from a tangent to the substantially circular central portion and the stirring portion extends radially from the connector portion.

4. The mixer of claim 3 wherein the central portion is coextensive with the open interior of the paddle assembly.

5. The fluid mixer of claim 1 wherein the front edge is angled from the rear surface of the paddle that extends radially further than the front surface of the paddle.

6. The fluid mixer of claim 1 wherein the front edge is contoured to match the curve of the wall.

7. The fluid mixer of claim 1 wherein the inner portion has an inner bottom and the outer portion has an outer bottom, wherein the inner bottom is held above the outer bottom and has a floor cutout that extends from the wall cutout.

8. The fluid mixer of claim 7, wherein the floor cutout has a front, a first side and a second side and wherein the first side meets the wall at a substantially acute angle and the second side meets the wall as a substantially obtuse angle.

9. The fluid mixer of claim 1, wherein the fluid mixer mixes at least one liquid with at least one powder, the fluid mixer further comprising:
a liquid inlet through which the at least one liquid is introduced into the fluid reservoir;
a powder inlet at a top of the fluid reservoir through which the at least one powder is introduced into the fluid reservoir.

10. The fluid mixer of claim 9, wherein the liquid inlet introduces the at least one liquid into the outer portion of the fluid reservoir and wherein the powder inlet is at least partially above the inner portion such that when the at least one powder is introduced through the powder inlet at least a portion of the at least one powder falls into the inner portion.

11. The fluid mixer of claim 9 further comprising a liquid measurer to allow a predetermined amount of the at least one liquid to be introduced into the fluid reservoir and a powder measurer to allow a predetermined amount of the at least one powder to be introduced into the fluid reservoir.

12. A method of mixing a fluid, the method comprising the acts of:
providing a powder dispenser arranged over a fluid mixer such that powder dispenser from the powder dispenser will be dropped into the fluid mixer, the fluid mixer comprising:
a fluid reservoir;
a ring within the fluid reservoir having a columnar wall defining an inner portion and an outer portion of the fluid reservoir, the wall having a plurality of wall cutouts that allow fluid to pass from the inner portion to the outer portion;
a stirrer rotatably coupled in the ring, the stirrer having a center and plurality of paddles, each paddle having a front surface, a rear surface and a front edge that extends nearly to the wall;
a motor to rotate the stirrer;
wherein the rear surface of a first paddle of the plurality of paddles and the front surface of a second paddle of the plurality of blades define a mixing space and wherein rotation of the paddles pushes a fluid from the mixing space through one of the plurality of cutouts into the outer portion;
introducing at least one liquid into the fluid reservoir and at least one powder into the powder dispenser;
activating the motor to rotate the stirrer and dispensing the at least one powder from the powder dispenser into the liquid while the stirrer is rotating.

13. The method of claim 12 wherein the fluid mixer further comprises a liquid measurer to allow a predetermined amount of the at least one liquid to be introduced into the fluid reservoir and a powder measurer to allow a predetermined amount of the at least one powder to be introduced into the fluid reservoir, the method further comprising the acts of:
allowing a user to set a predetermined volume of the at least one liquid and a predetermined weight of the at least one powder;
introducing the predetermined volume of the at least one liquid into the fluid reservoir; and
dispensing the predetermined weight of the at least one powder from the powder dispenser.

14. The method of claim 12 wherein the fluid mixer further comprises:
a liquid inlet through which the at least one liquid is introduced into the fluid reservoir;
a lid over the top of the fluid reservoir, the lid comprising a powder inlet through which the at least one powder is introduced into the fluid reservoir,
wherein the powder inlet is at least partially above the inner portion such that when the at least one powder is introduced through the powder inlet at least a portion of the at least one powder falls into the inner portion; and
wherein the method further comprises the acts of introducing a liquid through the liquid inlet into the outer portion of the fluid reservoir

15. The method according to claim 12, further comprising allowing a user to set the rotation speed of the stirrer between 1 rpm and 15,000 rpm.

16. The method of claim 12 further comprising stirring the at least one powder as the powder is being dispensed from the powder dispenser.
